(19) United States
(12) Patent Application Publication
(10) Pub. No.: US 2025/0304373 A1
(43) Pub. Date: Oct. 2, 2025

(54) STORAGE CONTAINERS FOR A GRID FRAMEWORK STRUCTURE

(71) Applicant: OCADO INNOVATION LIMITED, Hatfield, Herfordshire (GB)

(72) Inventor: Lars Sverker Ture LINDBO, Hatfield, Hertfordshire (GB)

(73) Assignee: OCADO INNOVATION LIMITED, Hatfield, Herfordshire (GB)

(21) Appl. No.: 18/863,101

(22) PCT Filed: May 5, 2023
(86) PCT No.: PCT/EP2023/062058

§ 371 Date: Nov. 5, 2024

(30) Foreign Application Priority Data
May 6, 2022 (GB) 2206691.4

(51) Int. Cl. B65G 1/137; B65G 1/04; F25D 3/00; F25D 11/00; G06Q 10/087

(52) U.S. Cl. CPC B65G 1/1371; B65G 1/0464; F25D 3/005; F25D 11/006; G06Q 10/087; B65G 2203/0216; F25D 2201/14

(57) ABSTRACT

A storage and retrieval system includes a grid framework structure including a track system forming a grid. A load handling device is moveable on the track system. Stacks of storage containers are arranged in each of a plurality of storage columns located beneath the track system. The load handling device includes a lifting device arranged to lift one or more storage containers, each including a base wall and opposing sidewalls and end walls extending from the base wall to form a box-like structure having an opening, and a lid for closing the opening to define a cooling tote. At least one of the base wall, and/or opposing sidewalls and/or opposing end walls and/or the lid of the cooling tote includes a pocket housing a refrigerant with a freezing point in a range of −30° C. to 0° C. for storing frozen or chilled foods.

### TECHNICAL FIELD

The present invention relates to the field of an automated storage and retrieval system comprising robotic load handling devices for handling storage containers stacked in the automated storage and retrieval system, more particularly to a storage container for the automated storage and retrieval system.

### INTRODUCTION

Storage and retrieval systems comprising a three-dimensional storage grid structure, within which storage containers/bins are stacked on top of each other, are well known. PCT Publication No. WO2015/185628A (Ocado) describes a known storage and fulfilment system in which stacks of bins or containers are arranged within a grid framework structure. The bins or containers are accessed by robotically controlled load handling devices operative on tracks located on the top of the grid framework structure. A system of this type is illustrated schematically in FIGS. 1 to 3 of the accompanying drawings.

As shown in FIGS. 1 and 2, stackable containers, known as bins 10, are stacked on top of one another to form stacks 12. For the purpose of definition, the terms ‘bin’, ‘tote’, ‘container’ and ‘storage container’ are used interchangeably in the description to mean the same feature. The stacks 12 are arranged in a grid framework structure 14 in a ware-housing or manufacturing environment. The grid framework structure is made up of a plurality of storage columns or grid columns. Each grid cell in the grid framework structure has at least one grid column for storage of a stack of containers. FIG. 1 is a schematic perspective view of the grid framework structure 14, and FIG. 2 is a top-down view showing a stack 12 of bins 10 arranged within the framework structure 14. Each bin 10 typically holds a plurality of product items (not shown), and the product items within a bin 10 may be identical, or may be of different product types depending on the application.

The grid framework structure 14 comprises a plurality of upright members 16 that support horizontal members 18, 20. A first set of parallel horizontal members 18 is arranged perpendicularly to a second set of parallel horizontal members 20 to form a plurality of horizontal grid cells supported by the upright members 16. The members 16, 18, 20 are typically manufactured from metal. The bins 10 are stacked between the members 16, 18, 20 of the grid framework structure 14, so that the grid framework structure 14 guards against horizontal movement of the stacks 12 of bins 10, and guides vertical movement of the bins 10.

The top level of the grid framework structure 14 includes rails 22 arranged in a grid pattern across the top of the stacks 12. Referring additionally to FIG. 3, the rails 22 support a plurality of load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

A known load handling device 30 shown in FIG. 4 comprises a vehicle body 32 and is described in PCT Patent Publication No. WO2015/019055 (Ocado), hereby incorporated by reference. Here, the load handling device 30 comprises a wheel assembly comprising a first set of wheels 34 consisting a pair of wheels on the front of the vehicle 32 and a pair of wheels 34 on the back of the vehicle 32 for engaging with the first set of rails or tracks to guide movement of the device in a first direction, and a second set of wheels 36 consisting of a pair of wheels 36 on each side of the vehicle 32 for engaging with the second set of rails or tracks to guide movement of the device in a second direction. The vehicle body of the load handling device comprises an upper portion and a lower portion. The wheels are arranged around the periphery of a cavity or recess, known as a container-receiving recess 40, in the lower portion of the vehicle body. The container-receiving recess is sized to accommodate the container 10 when it is lifted by the crane mechanism, as shown in FIG. 5 (a and b). The crane mechanism or container-lifting mechanism comprising a lifting drive assembly or winch assembly comprising a winch or a crane mechanism to lift a storage container or bin, also known as a tote, from above and a container gripping assembly or grabber device 39. The lifting mechanism is located in the upper portion of the vehicle body. The grabber device is formed as a frame comprising four corner sections. The winch crane assembly comprises a lifting tether 38 wound on a spool or reel (not shown). Typically, the winch assembly comprises four spools, each spool of the four spools carrying a lifting tether, having one end anchored to the spool and the other end anchored to a corner of the grabber device.

The container gripping assembly 39 is configured to grip the top of the container 10 to lift it from a stack of containers in a storage system of the type taught in PCT Patent Publication No. WO2015/019055 (Ocado). The winch assembly is driven by a drive mechanism (not shown), commonly known as a Z-motor for the reason that the Z-motor is configured to raise and lower the container gripping assembly in the Z direction when lifting and lowering a storage container. During operation of the drive mechanism when lowering the container gripping assembly, the lifting tether is paid out from the spool. When the storage container is lifted clear of the rails beneath and into the container receiving space of the load handling device, the vehicle or load handling device can move laterally to a different location. On reaching the target location, for example another stack, an access point in the storage system or a conveyor belt, the bin or container can be lowered from the container receiving portion and released from the grabber device.

Upon receipt of a customer order, a robotic load handling device operative to move on the tracks is instructed to pick up a storage bin containing the item of the order from a stack in the grid framework structure and transport the storage bin to a pick station whereupon the item can be retrieved from the storage bin. Typically, the load handling device transports the storage bin or container to a bin lift device that is integrated into the grid framework structure. A mechanism of the bin lift device lowers the storage bin or container to a pick station. At the pick station, the item is retrieved from the storage bin. Picking can be done manually by hand or by a robot as taught in GB2524383 (Ocado Innovation Limited). After retrieval from the storage bin, the storage bin is transported to a second bin lift device whereupon it is lifted to grid level to be retrieved by a load handling device and transported back into its location within the grid framework structure. A control system and a communication system keeps track of the location of the storage bins and their contents within the grid framework structure. As individual containers are stacked in vertical layers, their locations in the grid framework structure or ‘hive’ may be indicated using co-ordinates in three dimensions to represent the load handling device or a container's position and a container depth (e.g. container at (X, Y, Z), depth W). Equally, locations in the grid framework structure may be indicated in two dimensions to represent the load handling device or a container's position and a container depth (e.g. container depth (e.g. container at (X, Y), depth Z). For example, Z=1 identifies the uppermost layer of the grid, i.e. the layer immediately below the rail system, Z=2 is the second layer below the rail system and so on to the lowermost, bottom layer of the grid.

Various items can be stored and retrieved in the storage and retrieval system according to the present invention. However, where the items are grocery items of a perishable nature, provisions need to be put in place in the storage and retrieval system to store perishable grocery items. WO2021/209648 (Ocado Innovation Limited) teaches a multi-temperature storage system comprising: a storage structure including a plurality of upright members, a plurality of horizontal members supported by the upright members and forming a grid pattern defining a plurality of grid cells and allowing containers to be arranged in stacks beneath the grid cells defined by the grid pattern, and a track structure on top of the horizontal members. The track structure is configured to allow a load-handling device to move across the storage structure to retrieve a container from a stack. The multi-temperature storage system comprises temperature-control means configured to maintain a first-temperature region within the storage structure at a first temperature and a second-temperature region within the storage structure at a second temperature. The temperature-control means includes a temperature-control plant and tubing providing a closed loop along which temperature-control fluid is configured to flow from the temperature-control plant to the first-temperature region within the storage structure and from the first-temperature region within the storage structure to the temperature-control plant. The temperature-control means is described as a chill plant that chills air to a specified temperature and directs the chilled air along ducting to one or more locations in the grid framework structure.

The advantage of the storage and retrieval system as taught in WO2015/185628A (Ocado) over other storage systems known in the art is the ability to densely pack items in storage and the robotic load handling devices operable on the grid framework structure are able to at least automate the retrieval of items from storage in the grid framework structure for fulfilling customer orders. However, the problem with the provision of the temperature control means to direct chilled air to specified regions of the grid framework structure is not only the cost to cool certain regions of the grid framework structure but specified regions would need to be sufficiently insulated to prevent the ingress of warm air from the warmer regions of the grid framework structure such as the ambient regions. Since cold temperatures affect the storage capacity of the rechargeable power source powering the robotic load handling devices on the grid framework structure which is typically a battery, the multi-temperature storage and retrieval system known in the art is very much limited to storing chilled goods, which is in the temperature range of 1° C. to 4° C. Temperatures below this range in the frozen region, which is typically in the region of −25° C. to −18° C. would severely affect the storage capacity of the batteries to the extent that the batteries are unable to hold charge for an adequate period of time to have any useful purpose on the grid framework structure. As a result, frozen goods, e.g. ice cream, frozen meats etc., are typically stored in a separate area in a typical distribution centre or customer fulfilment centre to the grid framework structure and the picking of frozen goods to fulfil customer orders is very much limited to a manual operation removing the ability to automate the fulfilment of frozen items.

A multi-temperature storage and retrieval system is thus required that is able to store goods at a multitude of storing temperatures covering controlled ambient temperature, chilled and frozen temperatures so as to make use of the high storage capacity of the grid framework structure and the automation of retrieving the items from storage without suffering from the problems discussed above.

### SUMMARY OF THE INVENTION

The present invention has mitigated the above problem by the provision of a passive cooling system comprising one or more cooler packs in one or more walls of a thermally insulating storage container for storage in the grid framework structure. The use of one or more cooler packs enables temperature sensitive goods to be stored in the insulated storage containers at a predetermined temperature range. Cooler packs comprise a refrigerant that is able to be frozen to a predetermined temperature depending on the freezing point of the refrigerant. One example of a refrigerant that provides a cooling effect is a eutectic mixture of a solvent and one or more mineral salts which undergoes a phase change at a particular freezing point (or melting point) that is lower than the freezing point of the solvent. For example, the eutectic mixture may comprise glycol and/or may comprise salt water. Salt water is particularly advantageous for use in the cooling of food products because it is food safe. Commonly used cooler packs comprise an aqueous solution of mineral salts. The type of mineral salts used in the aqueous solution influences the freezing point or melting point of the eutectic mixture, and thereby influences the temperature range by which items can be stored in the insulated storage containers. When incorporated into a storage container, heat from the storage container is absorbed by the refrigerant causing the refrigerant to undergo a phase change as the refrigerant melts. This change of state occurs without a change of temperature and thus, the rate of change of temperature within the insulated storage container is reduced. The refrigerant is typically chilled in a refrigerator or freezer until the phase change material freezes and depending on the mineral salt the freezing point can be low as −30° C. when the refrigerant is a eutectic mixture. The cooling capacity of refrigerant is dependent on the quality and quantity of the refrigerant in the insulated storage container. The quality of the refrigerant is judged by the stability of its temperature plateau. As the refrigerant thaws, the refrigerant absorbs heat at an approximately constant temperature, i.e. the temperature curve in the thawing phase is generally flat and continuous. The quantity of the refrigerant in the insulated storage containers controls the amount of heat that can be extracted from the insulated storage container.

Providing a passive cooling system in the storage container allows goods to be stored at a wider range of temperatures that cannot be easily achieved with an active cooling system. The present invention, thus, provides a storage and retrieval system comprising:
a grid framework structure comprising a track system and a plurality of storage columns arranged adjacent to one another, said track system comprising a first set of parallel rails or tracks and a second set of parallel rails or tracks extending transverse to the first set in a substantially horizontal plane to form a grid pattern comprising a plurality of grid spaces;
a plurality of storage containers arranged in stacks in each of the plurality of storage columns, and located beneath the track system, each of the plurality of storage containers comprising a base wall and opposing sidewalls and end walls extending from the base wall to form a box-like structure having an opening and;
at least one load handling device disposed on the track system, arranged to move laterally above the stacks on the rails, the load handling device comprising a lifting device arranged to lift one or more containers, or parts thereof, from a stack, the lifting device comprising a container gripper assembly configured to releasably grip a storage container and a lifting drive assembly configured to raise and lower the container gripping assembly;
wherein one or more of the plurality of storage containers comprises a lid for closing the opening of the one or more storage containers to define a cooling tote;
wherein at least one of the base wall, and/or opposing sidewalls and/or opposing end walls and/or the lid of the cooling tote comprises a pocket or cavity housing a refrigerant;
wherein the refrigerant has a freezing point in the range of −30° C. to 0° C. for storing frozen or chilled foods.

The refrigerant can be integrated into one or more walls of the storage container such that one or more walls or lid of the storage container can function as an integrated cooler pack. The base wall, opposing sidewalls and opposing end walls form a box-like structure or enclosure within an interior storage space for storing goods or items in the grid framework structure. Optionally, the refrigerant is contained within the lid of the one or more cooling totes. The advantage of incorporating the refrigerant in the lid is the ability to replace the lid from one or more of the cooling totes when the refrigerant in the lid can no longer maintain the temperature within the cooling tote within a predetermined temperature range. For the purpose of definition of the present invention, the term ‘charge’ is used to describe the condition when the refrigerant remains in a frozen state for a predetermined length of time. Thus, when the refrigerant has run out of charge, this means that the refrigerant can no longer maintain the temperature within the cooling tote within a predetermined temperature range. As the dimensions and shape of the storage containers are substantially uniform to enable a plurality of the storage containers to be stacked in the grid framework structure, the lid of one or more of the cooling totes is easily exchangeable. In comparison to integrating the refrigerant into one or more of the bottom wall and/or sidewalls of the cooling tote, the lid is a less bulky component than the remainder of the cooling tote allowing multiple lids to be placed in a refrigeration system comprising a refrigeration or cooling chamber to be charged without occupying too much space. The lid comprising the refrigerant may be termed a ‘refrigerant plate’. The refrigerant may have a freezing point in the range −30° C. to −15° C. such that the refrigerant plate is defined as freezer plate. The refrigerant may alternatively have a freezing point in the range −5° C. to −0° C. such that the refrigerant plate is defined as a chilled plate.

Instead of the lid comprising a refrigerant, the refrigerant may be contained within a plate to define a refrigerant plate such that when the refrigerant has a freezing point in the range −30° C. to −15° C., the refrigerant plate is defined as freezer plate and when the refrigerant has a freezing point in the range −5° C. to 0° C., the refrigerant plate is defined as a chilled plate.

Containing the refrigerant in a plate allows the refrigerant plate to be removably receivable within the pocket of the at least one of the base wall, and/or opposing sidewalls and/or opposing end walls and/or the lid of the cooling tote. Instead of integrating the refrigerant into one or more walls of the storage container, containing the refrigerant in a refrigerant plate allows the refrigerant to be replaced by a fully frozen or charged refrigerant when the refrigerant in the plate has fully thawed or nearly fully thawed and can no longer effectively cool the contents of the storage container. There are different types of refrigerant plates and each type of the refrigerant plate depends on the type of refrigerant contained within the plate. For storing and cooling frozen goods, the refrigerant has a freezing point in the range −30° C. to −15° C. (for example, the freezing point may be −25° C., −20° C.) and for the purpose of definition is defined as a freezer plate. For storing and cooling chilled goods, the refrigerant has a freezing point in the range −5° C. to 0° C. (for example, the freezing point may be −4° C., −3° C., −2° C., or −1° C.) and for the purpose of definition is defined as a chilled plate.

For maintaining the temperature in the chilled zone, this amounts to a temperature range of 2° C. to 8° C. and for maintaining a temperature in the frozen or freezer zone, this amounts to a temperature range of −30° C. to −15° C. For storing goods in the chilled temperature range, preferably, the refrigerant has a freezing point in the temperature range −5° C. to 0° C. and for storing goods in the frozen temperature range, preferably, the refrigerant has a freezing point in the temperature range −30° C. to −15° C. In the case where the refrigerant has a freezing point in the temperature range −30° C. to −15° C., the refrigerant can be a eutectic mixture. The advantage of using a eutectic mixture is that its freezing point can be tailored depending on the storage requirements of the goods in question. When the composition of the refrigerant is tailored to provide cooling to store goods in the frozen temperature range, the cooling tote can be defined as a freezer tote. Accordingly, where the composition of the eutectic mixture is tailored to provide cooling to store goods in the chilled temperature range, the cooling tote can be defined as a chilled tote.

To allow the cooling totes of the present invention to be stacked in the grid framework structure in an ambient temperature environment, optionally, at least a portion of the at least one base wall, opposing sidewalls and/or opposing end walls and/or the lid of the one or more cooling totes is thermally insulating. Optionally, at least a portion of the at least one base wall, opposing sidewalls and/or end walls and/or the lid of the one or more cooling totes comprises a thermally insulating foam so as to reduce or prevent heat from the ambient environment external of the one or more cooling totes from transferring through the at least one base wall, opposing sidewalls and/or the lid of the one or more cooling totes which would warm the interior storage space of the one or more cooling totes. The transfer of heat through the walls of the cooling totes not only heats the interior storage space of the cooling totes but also accelerates the thawing of the refrigerant within one or more walls of the cooling tote from its charged state reducing the ability of the refrigerant to cool the interior storage space of the cooling tote. This reduces the effectiveness of the cooling totes to store and cool items at temperatures lower than the ambient temperature. If the items are perishable grocery items, elevation of the temperature beyond the required storage temperature of the perishable items for a predetermined length of time may spoil the perishable items to the extent that the items may be classed as being unsafe for consumption and in a worst case scenario result in harmful bacteria developing in the perishable items. The thermally insulating foam also prevents cooled air from exiting the interior storage space of the cooling tote. Optionally, the thermally insulating foam comprises polyurethane foam and/or polystyrene foam.

Optionally, the at least one of the base wall, opposing sidewalls and end walls and/or the lid of the one or more cooling totes comprises a vacuum insulated core. Other means to prevent transfer of heat from the ambient environment transferring into the interior storage space of the cooling totes is to provide a vacuum insulated core in at least one of the base wall, opposing sidewalls and end walls and/or the lid of the one or more cooling totes so as to prevent conductive and convective heat transfer through the walls of the cooling totes. Optionally, the vacuum insulated core may form part of a vacuum insulated panel.

An advantage of storing items in a grid framework structure is the ability to provide a densely packed storage system as the storage containers can be densely packed together into a plurality of stacks of storage containers. The stacks of storage containers can be as high as twenty-one storage containers high and since each of the storage containers in a stack can weigh as much as 35 kg, this adds a lot of weight on the storage containers lower down in the stack. Forming the base wall, opposing sidewalls and end walls of the cooling tote from a thermally insulating material such as a thermal insulating foam suffers from the problem of not having sufficient structural rigidity to support the weight of multiple storage containers above in a stack. To prevent the walls of the cooling totes from crushing under the weight of the storage containers or cooling totes above in a stack, optionally, the base wall and the opposing sidewalls and opposing end walls extending from the base wall of the box-like structure of each of the one or more cooling totes form an inner shell and each of the one or more cooling totes further comprises a rigid outer shell housing the inner shell. The rigid outer shell of the cooling tote provides structural rigidity to compensate for the lower strength thermal insulation material of the inner shell when the cooling totes are stacked one above the other in the grid framework structure. The rigid shell can be made out of any rigid material known in the art such as metal, plastic material, etc.

The more exposure of the refrigerant to the interior storage space of the cooling tote, the greater the rate of heat transfer between the air in the interior storage space and the refrigerant and thus, the greater the cooling effect, i.e. more frigories of cooling power from the refrigerant are available to cool the interior storage space of the cooling tote. A frigorie is a unit of rate of extraction of heat, equal to one calorie per hour. To maximise exposure of the refrigerant in at least one of the base wall and/or the opposing sidewalls and/or opposing end walls and/or lid of the cooling tote, optionally, the at least one of the base wall, and/or opposing sidewalls and/or opposing end walls and/or the lid of each of the one or more cooling totes comprising the pocket comprises one or more cut-outs extending into the interior of the box-like structure such that at least a portion of the refrigerant plate is exposed in the interior space of the one or more cooling totes.

The refrigerant has a limited ‘cooling time’ before the refrigerant would need to be charged in a refrigeration or cooling chamber, i.e. re-frozen. For the purpose of definition according to the present invention, the term ‘cooling time’ is construed to mean the duration of time that the refrigerant plate, e.g. eutectic plate, provides cooling in one or more cooling totes. In other words, it is the time that has elapsed when the refrigerant plate is in the cooling tote. Typically, standard eutectic plates which provide a cooling effect in the temperature range of −30° C. to −15° C. have a cooling time with a predetermined cooling duration of up to 12 hours or even in the range 24 hours to 30 hours before the eutectic plates would need to be re-charged. To allow the refrigerant plates to be re-charged, preferably, the refrigerant plate is removably receivable within the pocket of the at least one of the base wall, and/or opposing sidewalls and/or opposing end walls and/or the lid of each of the one or more cooling totes.

Since the cooling time of the refrigerant plate has a limited predetermined cooling duration, it is necessary that the cooling time of the refrigerant plate is monitored when the cooling tote incorporating the refrigerant plate is placed in the grid framework structure so as to determine when the refrigerant plate would need to be re-charged, otherwise there is the risk that refrigerant would completely thaw out in the cooling totes removing its ability to provide a cooling effect to the interior storage space and contents of the cooling tote. Optionally, the storage and retrieval system according to the present invention further comprises a control system comprising one or more processors and memory storing instructions that when executed by the one or more processors is configured to determine the duration of time of the one or more cooling totes in the grid framework structure by:
i) recording a start time when the refrigerant plate is placed in at least one of the base wall, and/or opposing sidewalls and/or opposing end walls and/or the lid of each of the one or more cooling totes;
ii) determining the duration of time that has elapsed in the one or more cooling totes from the recorded start time to define a cooling time; and
   if the cooling time exceeds or approaches a predetermined cooling duration, instructing a robotic load handling device operable on the track structure of the grid framework structure to remove the one or more cooling totes from the grid framework structure.

The cooling time is defined as the time that has elapsed when the refrigerant is in the at least one of the base walls, and/or opposing sidewalls and/or opposing end walls and/or the lid of the one or more cooling totes. The cooling time depends on the quality and quantity of the refrigerant in the eutectic plate. Typically, the cooling time has a predetermined cooling duration in the range of 8 hours to 12 hours or 24 hours to 30 hours to provide a cooling effect of −30° C. to −15° C. or 2° C. to 8° C. If the time that has elapsed from the start time when the refrigerant plate is placed in at least one of the base wall, and/or opposing sidewalls and/or opposing end walls and/or the lid of each of the one or more cooling totes, i.e. the cooling time exceeds a predetermined cooling duration, then the control system can instruct one or more robotic load handling devices operable on the grid framework structure to retrieve the cooling tote comprising the suspect refrigerant plate such that the refrigerant plate can be replaced with a charged refrigerant plate from a cooling station. The expended refrigerant plate can be re-charged by placing the expended refrigerant plate in a cooling chamber so as to re-freeze any refrigerant that has thawed out in the expended refrigerant plate. The cooling time re-starts as soon as the expended refrigerant plate has been replaced with a fully charged plate in the cooling tote. Since the one or more cooling totes are subsequently stored in the grid framework structure as soon as one or more charged refrigerant plates is placed in the one or more cooling totes, the start time can be the time when the one or more cooling totes enter the grid framework structure.

Once the cooling time exceeds or approaches a predetermined cooling duration to provide a useful cooling effect in the cooling tote, optionally, the one or more cooling totes are removed to a cooling station comprising a plurality of refrigerant plates, said cooling station comprises a refrigeration system for cooling a plurality of the refrigerant plates in the temperature range of −25° C. to −15° C. or 2° C. to 8° C. such that one or more refrigerant plates in the one or more retrieved cooling totes can be replaced by one or more refrigerant plates from the cooling station.

For the control system to determine the status of the refrigerant plate in the cooling tote, optionally, each of the plurality of refrigerant plates comprises a label for identifying each of the plurality of refrigerant plates. By being able to identify a refrigerant plate, the control system is able to assign a start time to a particular refrigerant plate when the refrigerant plate is placed in the cooling tote and store the data associated with the identification of the refrigerant plate and the start time in a database. The label can comprise any one of a barcode, 1-D barcode, 2-D barcode, or a QR code or a RFID tag. Depending on the type of label, a radio frequency identification reader, a linear and/or matrix barcode reader, a payment card reader, a smart card reader, an infra-red reader can be used to read the label. To determine the type of refrigerant plate in the cooling tote, preferably, the identity comprises data associated with whether the refrigerant plate is a freezer plate or a chilled plate. The label may be readable by an input device for establishing an identity of each of the plurality of refrigerant plates in the cooling station or cooling tote or grid framework structure.

The start time can then be used by the control system to determine the status of the refrigerant plate when placed in the cooling tote. Optionally, the control system is configured:
i) to assign an identity of one or more refrigerant plates to the one or more cooling totes;
ii) to track the position of the one or more cooling totes within the grid framework structure;
iii) to store the position of the one or more cooling totes in the grid framework structure in a database.

Preferably, the control system is configured to assign the identity of one or more refrigerant plates to the one or more cooling totes depending on whether the goods are chilled goods or frozen goods. Different types of refrigerant plates are used in the cooling totes depending on whether the goods are frozen goods or chilled goods. One or more freezer plates are used in cooling totes for storing frozen goods and one or more chilled plates are used in cooling totes for storing chilled goods. The identity of the refrigerant plates comprises data associated with the type of refrigerant plate and this is assigned to one or more cooling totes depending on whether the goods in the one or more cooling totes are frozen goods or chilled goods.

By tracking the position of the cooling totes stored in the grid framework structure, the control system is able to instruct a robotic load handling device to retrieve a cooling tote whenever the cooling time of the refrigerant plate in the cooling tote has exceeded or is approaching its predetermined cooling duration. The position of the robotic load handling device on the track system can be used to determine the position of the cooling tote in the grid structure in the X-Y plane. For example, sensors at the intersection of the tracks extending the X and Y axis can be used to determine the position of the robotic load handling device in the horizontal plane on the track system and the position of the cooling tote vertically in a stack of storage containers can be determined from the depth the cooling tote is lowered in a given stack.

Optionally, the control system is configured to monitor the status of one or more cooling totes in the grid framework structure by:
i) retrieving data associated with the identification of one or more refrigerant plates in the database;
ii) correlating the identification of the one or more refrigerant plates to one or more cooling totes in the grid framework structure;
iii) determining the status of the one or more refrigerant plates by comparing the cooling time of the one or more refrigerant plates to its respective predetermined cooling duration.

Here, the control system monitors the status of one or more cooling totes in the grid framework structure by determining the length of time a cooling tote has been left in storage in the grid framework structure by comparing the length of time the refrigerant plate has been left in the cooling tote, i.e. cooling time, with its predetermined cooling duration. If the cooling time exceeds or is approaching its predetermined cooling duration, this is an indication to the control system that the refrigerant plate in the cooling tote needs to be charged, i.e. placed in the freezer. Data associated with correlation of the identification of the one or more refrigerant plate to one or more cooling totes in the grid framework structure may be stored in a lookup table. Once, the control system has identified the cooling tote comprising the refrigerant plate that needs to be recharged, optionally, the control system is configured to retrieve a cooling tote from the grid framework structure by:
i) retrieving data associated with the position of the cooling tote in the grid framework structure from the lookup table;
ii) instructing a robotic load handling device operable on the track system to retrieve the cooling tote from the grid framework structure using the position data.

The data associated with the position of the cooling tote in the grid framework structure can be represented by X, Y and Z coordinates. Typically, the container gripper assembly is adapted to engage with the top of the cooling tote, e.g. mate with corresponding engagement features in the rim that forms the top surface of the cooling. Optionally, the cooling tote may comprise a plurality of openings or holes for engagement with the container gripping assembly. Individual storage containers including the cooling tote may be stacked in vertical layers, and their locations in the grid framework structure or ‘hive’ may be indicated using co-ordinates in three dimensions to represent the robotic load handling device or a storage container's position and a storage container depth (e.g. container at (X, Y, Z), depth W). Equally, locations in the grid framework structure may be indicated in two dimensions to represent the robotic load handling device or a storage container's position and a storage container depth (e.g. container at (X, Y), depth Z)). For example, Z=1 identifies the uppermost layer of the grid, i.e. the layer immediately below the rail system, Z=2 is the second layer below the rail system and so on to the lowermost, bottom layer of the grid. The first set of parallel rails guide movement of the robotic load handling devices in the X-direction across the top of the grid framework structure, and the second set of parallel rails, arranged perpendicular to the first set, guide movement of the robotic load handling devices in the Y-direction, perpendicular to the first direction. Once the control system has identified the position of the cooling tote in the grid framework structure, the robotic load handling device can then be instructed to retrieve the cooling tote from the grid framework structure using the position data stored in the database.

### BRIEF DESCRIPTION OF DRAWINGS

Further features and aspects of the present invention will be apparent from the following detailed description of an illustrative embodiment made with reference to the drawings, in which:

FIG. 1 is an illustration of an automated storage and retrieval system according to an exemplary embodiment of the present invention

FIG. 2 is a schematic diagram of a top down view showing a stack of bins arranged within the framework structure of FIG. 1.

FIG. 3 is a schematic diagram of a system of a known load handling device operating on the grid framework structure.

FIG. 4 is a schematic perspective view of the load handling device showing the container receiving space within the body of the load handling device.

FIGS. 5(a) and 5(b) are schematic perspective cutaway views of the load handling device of FIG. 4 showing (a) a container accommodating a container receiving space of the load handling device and (b) the container receiving space of the load handling device.

FIG. 6(a) is a schematic side-on view of a grabber device of the load handling device and FIG. 6(b) is a schematic perspective view of the grabber device of the load handling device.

FIG. 7 is a schematic perspective view of an assembled cooling tote.

FIG. 8 is a schematic perspective view of the cooling tote of FIG. 7 with the lid lifted above the opening of the cooling tote.

FIGS. 9 and 10 are schematic perspective views of two embodiments of a cooling tote comprising a refrigerant plate stored in the lid of the cooling tote.

FIGS. 11 and 12 are schematic perspective views of two embodiments of a cooling tote comprising a refrigerant plate stored in the base wall of the cooling tote.

FIGS. 13 and 14 are schematic perspective views of two embodiments of a cooling tote comprising refrigerant plates stored in the opposing side walls of the cooling tote.

FIGS. 15(a), 15(b) and 15(c) are schematic perspective views of different configurations of refrigerant plates in the cooling totes.

FIG. 16 is a schematic perspective view of a trolley storing a plurality of cooling totes.

FIG. 17 is a schematic perspective view of a cooling station housing a plurality of the trollies shown in FIG. 16.

FIGS. 18(a) and 18(b) are illustrations of an automated storage and retrieval system comprising stacks of ambient storage containers and cooling totes within the grid framework structure.

FIGS. 19(a) and 19(b) are illustrations of an automated storage and retrieval system comprising cooling totes stacked in a specific region of the grid framework structure.

FIG. 20 is a schematic representation of the cooling control system according to an embodiment of the present invention.

FIG. 21 is an example of a flowchart giving a brief outline of the stages in preparing a cooling tote for storage in the grid framework structure.

FIG. 22 is an example of a flowchart detailing the stages in monitoring the status of the cooling totes in storage in the grid framework structure.

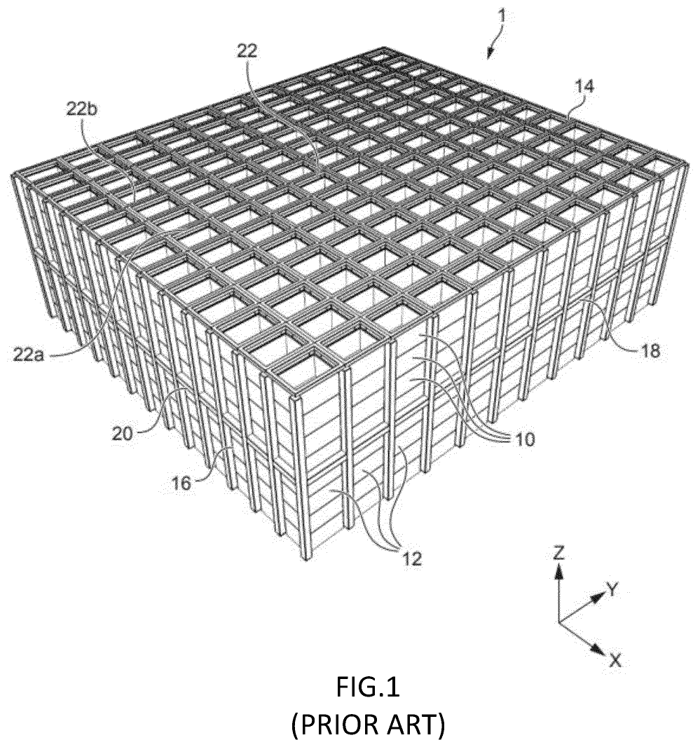

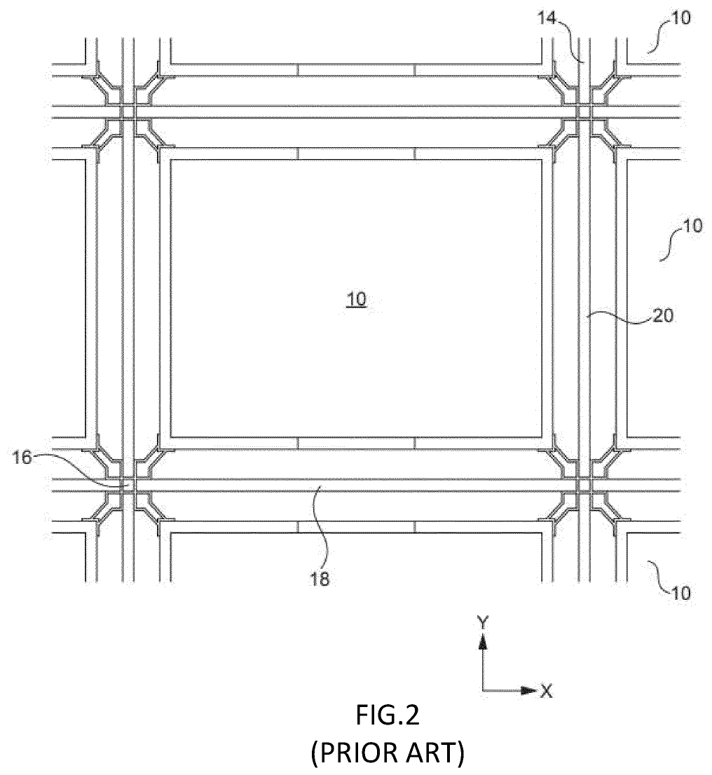

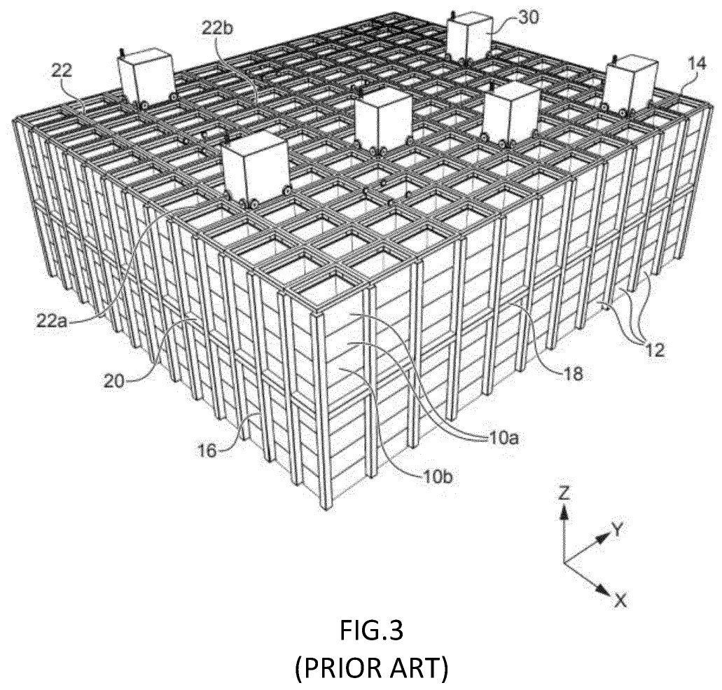

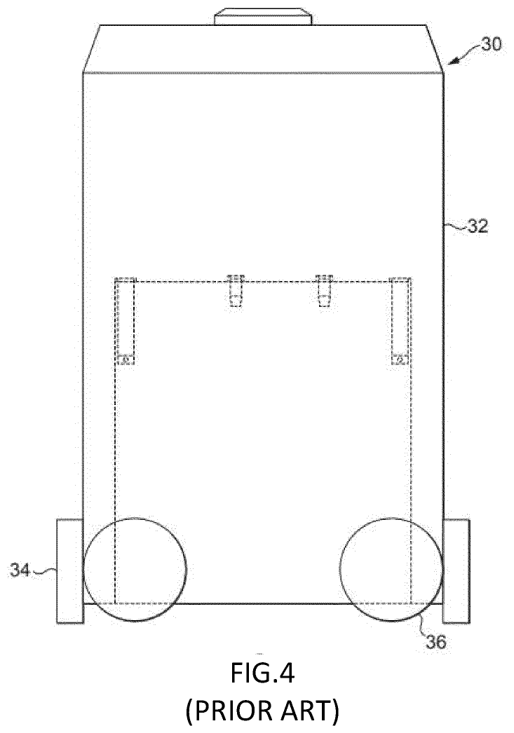

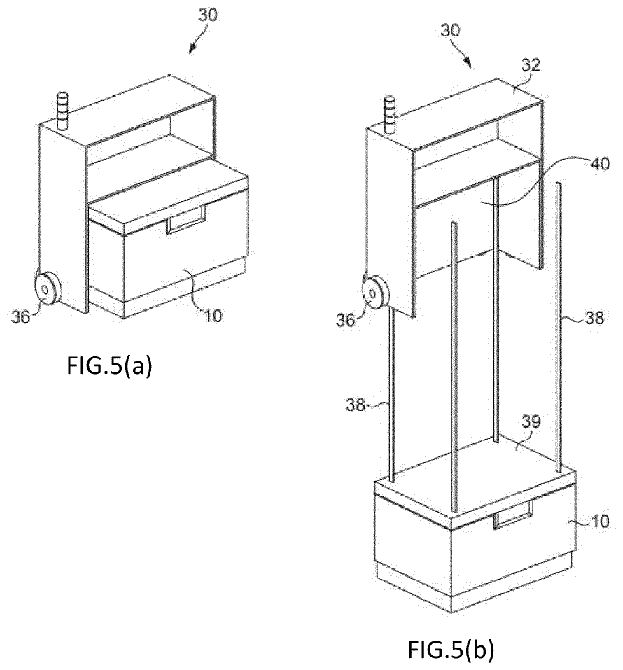

### DETAILED DESCRIPTION

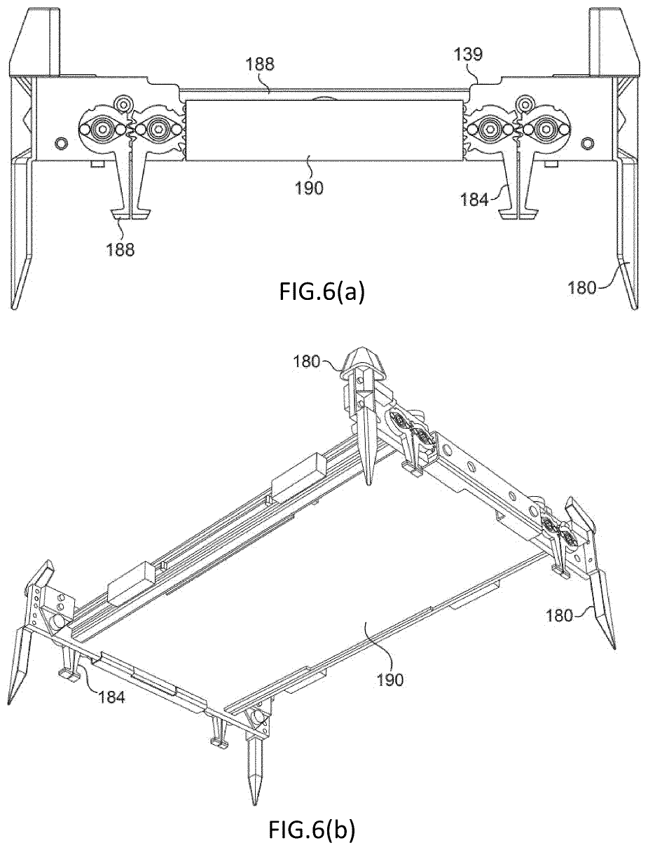

The present invention provides a storage and retrieval system in which storage containers arranged in stacks in a grid framework structure are retrievable from the grid framework structure by a load handling device. The load handling device comprises a lifting device and a gripping assembly for connecting to and lifting the storage container. FIG. 6 shows a container gripping assembly 139, otherwise known as a grabber device, for releasably attaching to a storage container 10 below. The grabber device comprises gripper elements 184 comprising a pair of wings that are collapsible so as to be receivable in corresponding holes or openings in an upper edge of a storage container. The wings are actuated into open and closed configurations by a suitable actuating mechanism coupled to a drive gear. More specifically, the head of at least one of the wings comprises a plurality of teeth that mesh with the drive gear such that when the gripper elements 184 are actuated by the actuating mechanism, rotation of the drive gear causes the pair of wings to rotate from a closed or collapsed configuration to an open enlarged configuration. When in the collapsed or closed configuration, the gripper elements 184 are sized to be receivable in corresponding holes in the upper edge of a container. The foot of each of the pair of wings comprises a stop 188, e.g. a boss, such that when received in a corresponding hole in the upper edge of the container, the stop 188 engages with an underside of the upper edge when in an enlarged open configuration thereby locking onto the container when the grabber device 139 is winched upwards towards the container-receiving portion of the load handling device.

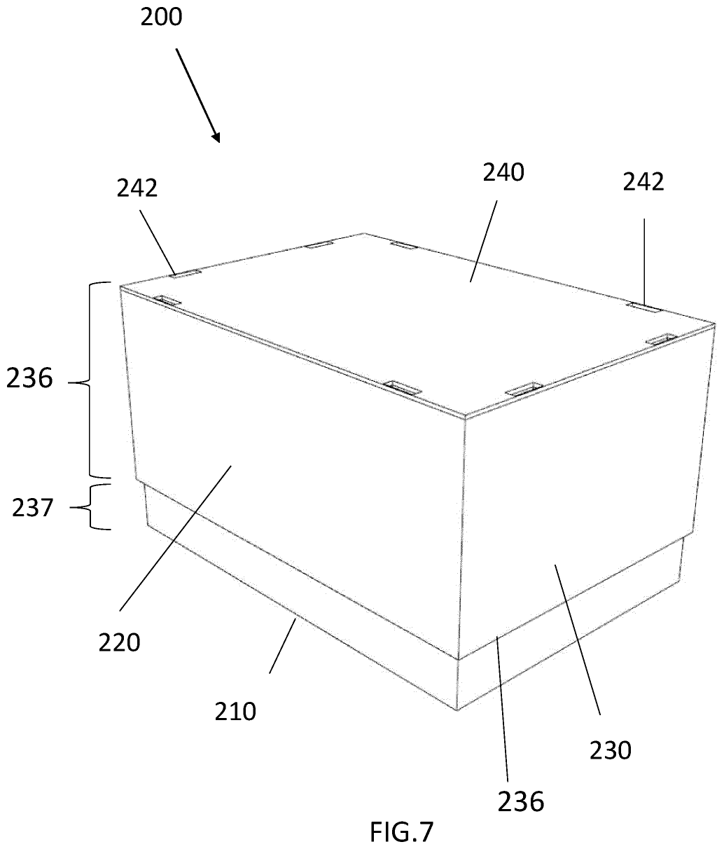

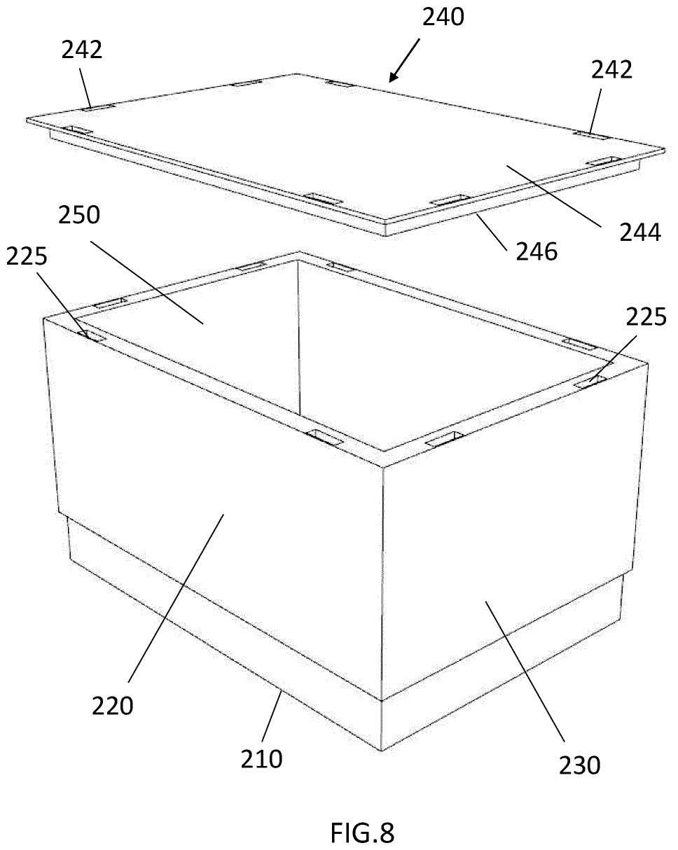

FIG. 7 shows a cooling tote 200 according to the present invention. The cooling tote is a type of storage container 10 which can store frozen or chilled foods. Frozen items are generally stored at −18° C. or below −18° C. and chilled items are stored at between 2° C. to 8° C. The cooling tote 200 is the same or substantially the same size and shape as storage containers 10 used for storage of ambient temperature items in the grid structure. The terms ‘ambient storage container’ or ‘standard storage container’ are used in this patent application to describe storage containers used for storing items at ambient temperature, and to differentiate from a cooling tote used for storing frozen or chilled foods. The cooling tote shown in FIG. 7 comprises a base wall 210, side walls 220 and end walls 230. The side walls 220 and end walls 230 extend upwardly from the base wall 210 to form a box-like structure having an opening 250 (FIG. 8). The cooling tote 200 also comprises a lid 240. The lid 240 comprises holes or openings 242 which are arranged such that the gripper elements 184 of the grabber device 139 (FIG. 6) can engage and lock onto the cooling tote 200.

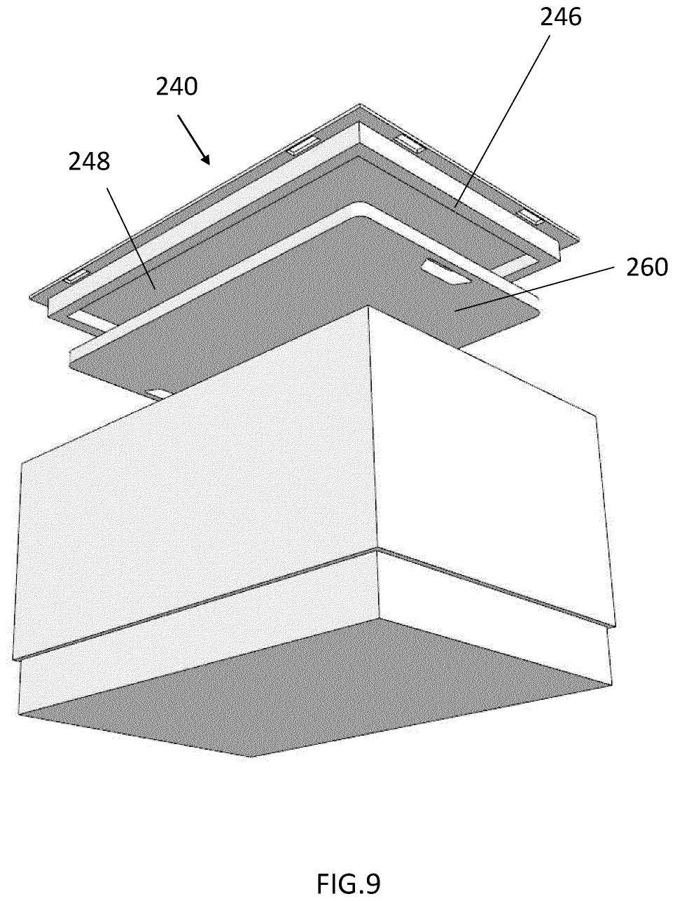

FIG. 8 shows the cooling tote of FIG. 7 with the lid 240 lifted from the side walls and end walls of the tote. The cooling tote further comprises holes 225 in an upper edge of the opposing sidewalls 220 and end walls 230. The holes 225 are located such that when the lid is on the cooling tote, the holes 225 are aligned with holes 242 in the lid, such that the gripper elements 184 of the grabber device 139 can engage and lock onto the cooling tote 200. The lid 240 comprises an exterior surface 244 and an interior surface 246. The exterior surface 244 is exposed to an ambient external environment. The interior surface 246 is sized and shaped such that it fits into the opening 250 of the cooling tote. Specifically, the interior surface 246 of the lid 240 has a size and shape such that it fits tightly in the opening 250 to form an enclosed interior storage space, otherwise termed an interior space. The chilled and/or frozen grocery items are kept cool in the interior space of the cooling tote as a result of the composition of the sidewalls, end walls, base wall and/or lid, as now explained, and in addition by the use of a refrigerant plate shown in FIG. 9. The opposing sidewalls 220, opposing end walls 230, base wall 210 and/or lid 240 comprise a thermally insulating material so heat from the ambient environment external of the cooling tote is prevented or reduced from transferring through the base wall, opposing side walls, end walls and/or lid to warm the interior space. The thermally insulating material may be a foam. Using a thermally insulating foam is particularly advantageous because gas bubbles within the foam conduct heat less effectively than solids and trapping gas within the foam prevents the gas from transferring heat by convection. Polyurethane and polystyrene foams are two such thermally insulating foams that could be used. If the cooling tote comprises a thermally insulating material, the base wall, opposing sidewalls and opposing end walls can comprise a rigid outer shell housing (not shown) to provide sufficient structural rigidity to support the weight of multiple storage container above in a stack. The rigid outer shell housing may be made from metal or plastic. Alternatively, or additionally, at least one of the base wall, opposing sidewalls, end walls and/or lid may comprise a vacuum insulated core. The vacuum insulated core has no or little thermal conductivity as a result of the absence or near absence of air. Specifically, the vacuum insulated core eliminates heat transfer by convection. Using a vacuum insulated core means that the at least one of the base wall, opposing sidewalls, end walls and/or lid can be made very thin, thereby increasing the size of the interior space in the cooling tote. The opposing sidewalls, end walls, base wall and/or lid may be made from vacuum insulated panels which comprise membrane walls to prevent ambient air from entering the panel and a panel of rigid, highly porous material to support the membrane walls once air has been evacuated from the panel. The highly porous material may be, for example, glass fibre, perlite, aerogel or fumed silica. Chemicals can be added to the vacuum insulated core to collect any gases leaked through the membrane.

FIG. 9 shows the cooling tote of FIGS. 7 and 8 with an additional feature of a refrigerant plate 260. The refrigerant plate comprises a refrigerant for cooling the interior space of the cooling tote. In the embodiment shown in FIG. 9, the refrigerant plate 260 is contained within the lid 240 of the cooling tote. An advantage of storing the refrigerant plate in the lid is that the cool air emitted from the refrigerant plate descends to the bottom of the cooling plate because of the higher density of cool air compared to warm air. Specifically, the refrigerant plate 260 is contained within a pocket 248 in the lid 240. The pocket 260 is located in the interior surface 246 of the lid. The refrigerant plate 260 is removably receivable within the pocket 248 in the lid 240. There is a snap-fit or push-fit arrangement between the refrigerant plate 260 and the pocket 248, such that the refrigerant plate 260 can be snapped or pushed into the pocket 248 and the refrigerant plate 260 is retained in the pocket 248. The interior surface of the lid may additionally comprise clips, fastenings etc. to hold the refrigerant plate 260 in place in the pocket 248. As shown in FIG. 9, one side of the refrigerant plate is completely exposed to the interior space of the cooling tote, thus increasing the thermal transfer between the air in the interior storage space and the refrigerant and thus, the greater the cooling effect. Thus, the refrigerant plate forms part of the interior surface of the lid. Grocery items in the interior space of the cooling tote may therefore make direct contact with the refrigerant plate 260 in the lid 240, and keep the items cool by thermal conduction. Further, the refrigerant plate circulates cold air through the enclosed interior storage space, thus keeping grocery items in the interior storage space cool by thermal convection.

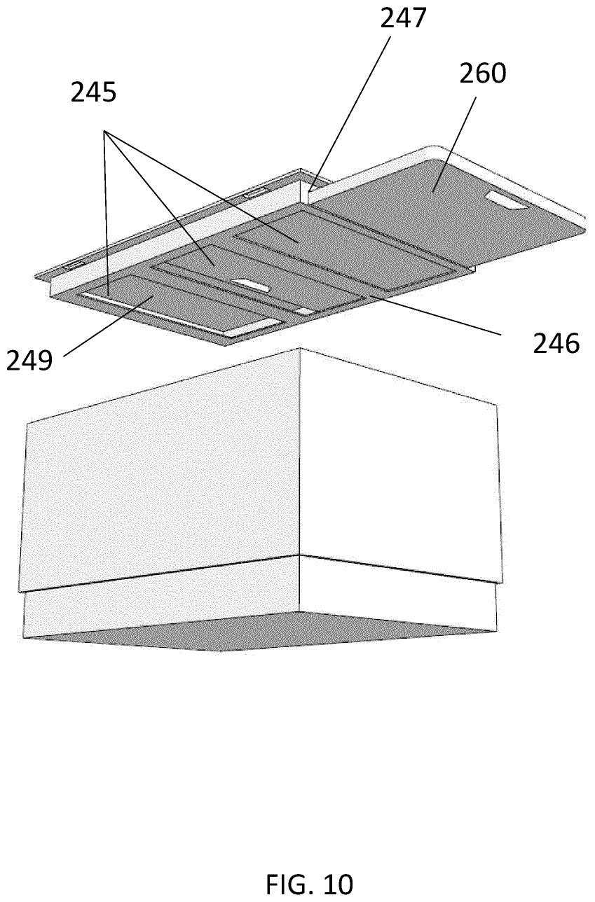

Alternatively, the refrigerant plate may be slid into a pocket in the lid, as shown in FIG. 10. The refrigerant plate 260 is receivable within a pocket 249 in the lid via a slot 247 in the lid 240 which forms an entrance to the pocket 249. The slot 247 has a width and height such that the refrigerant plate 260 can slide through the slot 247 into the cavity 249. In contrast to the embodiment shown in FIG. 9 in which the refrigerant plate is snap-fitted into and retained in the pocket 248, in FIG. 10, the refrigerant plate 260 is held in place in the pocket 249 by the interior surface 246 of the lid. The interior surface 246 of the lid comprises cut-outs 245 to allow cool air to flow into the interior space. There are three cut-outs 245 shown in FIG. 10 and each of the cut-outs is equal in size and shape. Any size and shape of cut-outs may be used to allow cool air to flow from the refrigerant plate 260 to the interior space, however larger cut-outs result in more efficient operation of the cooling tote.

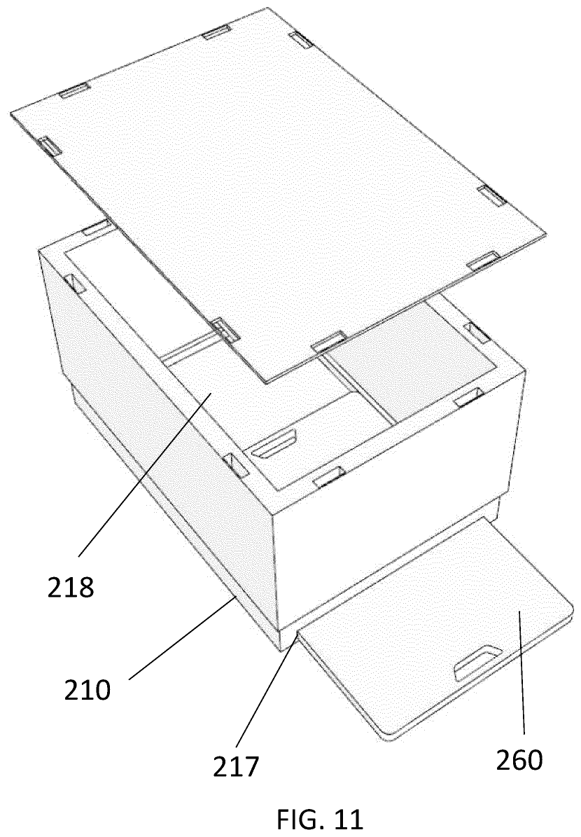

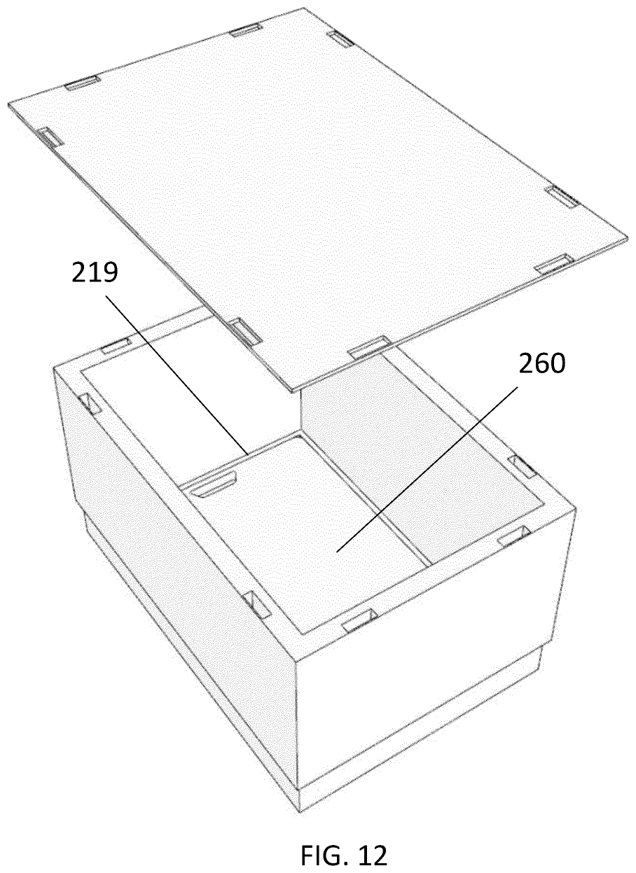

The refrigerant plate may alternatively be contained within the base wall of the cooling tote, as shown in FIGS. 11 and 12. FIG. 11 shows one arrangement of the cooling tote where the refrigerant plate 260 is receivable within a pocket 218 in the base wall via a slot 217 which forms an entrance to the pocket 218. The slot 217 is located in the base wall 210. Once the refrigerant plate is positioned in the pocket 218, one side of the refrigerant plate 260 is fully exposed to the interior space of the cooling tote. Thus, the refrigerant plate forms part of an interior surface of the base wall. Grocery items in the interior space of the cooling tote therefore make direct contact with the refrigerant plate and the items are cooled by thermal conduction. FIG. 12 shows another arrangement of the cooling tote where the refrigerant plate 260 is receivable within a pocket 219 in the base wall and the refrigerant plate 260 is snapped or pushed into the pocket 219. Clips or fasteners (not shown) may also be used to hold the refrigerant plate in position in the pocket 219. Once the refrigerant place is positioned in the pocket, one side of the refrigerant plate is fully exposed to the interior space of the cooling tote. Thus, the refrigerant plate forms part of an interior surface of the base wall.

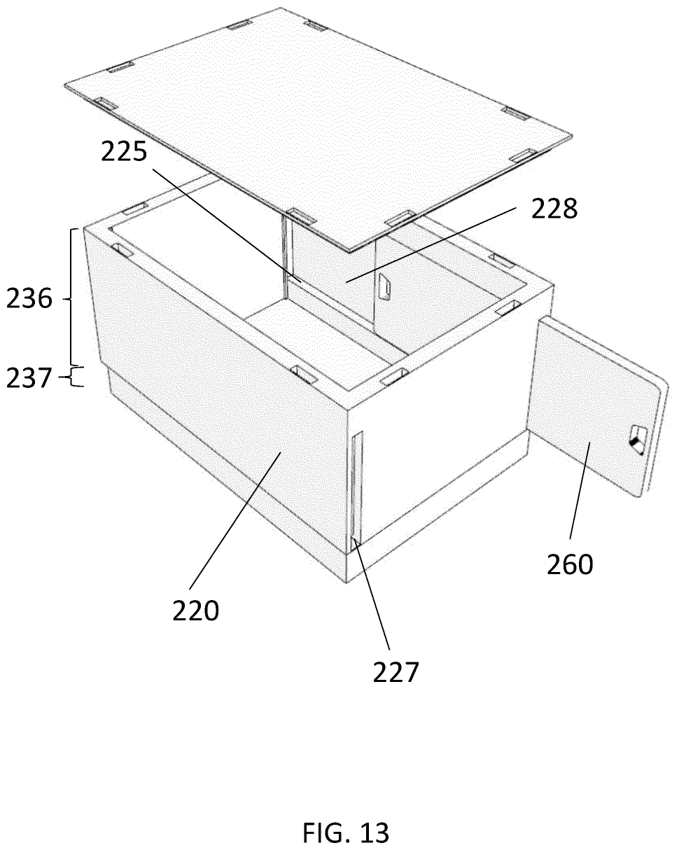

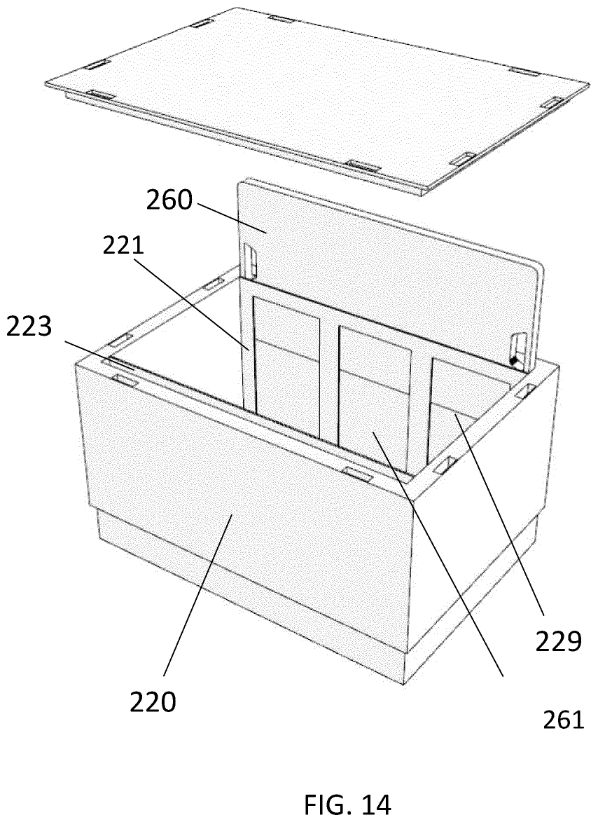

The refrigerant plate may alternatively be contained within the side wall of the cooling tote as shown in FIGS. 13 and 14. In order for the side walls to accommodate a refrigerant plate, the side walls are stepped such that an upper portion 236 of the side walls is wider than a lower portion 237 of the side walls. In FIG. 13 the refrigerant plate is receivable within a pocket 228 in the sidewall 220 via a slot 227 which forms an entrance to the pocket 228. The slot 227 is located in the side wall such that the refrigerant plate 260 can be slid horizontally into the pocket 228. The side walls 220 comprise sliding surfaces 225 onto which the refrigerant plate can more easily slide into the pocket 228. Adjacent to the sliding surfaces may be one or more protruding lips (not shown) in order to hold the refrigerant plate in position as it is being slid into the pocket, and also to hold the refrigerant plate in position once it is fully inside the pocket. Alternatively, clips or other fastening mechanisms may be used to hold the refrigerant plate in position in the pocket. One side of the refrigerant plate 260 is fully exposed to the interior space of the cooling tote when the refrigerant plate is in position in the pocket 228 to allow efficient cooling of the interior space. Thus, the refrigerant plate forms part of an interior surface of the sidewall.

FIG. 14 shows another arrangement of the cooling tote where the refrigerant plate 260 is receivable within a pocket 229 in the side wall via a slot 223 which forms an entrance to the pocket 229. The slot is located in the side wall such that the refrigerant plate 260 can be slid vertically or dropped into the pocket 229. The refrigerant plate 260 is held in place in the pocket 229 in the sidewall 220 by an interior surface 221 of the sidewall 220. The interior surface 221 of the side wall 220 comprises cut-outs 261 similar to those shown in FIG. 10.

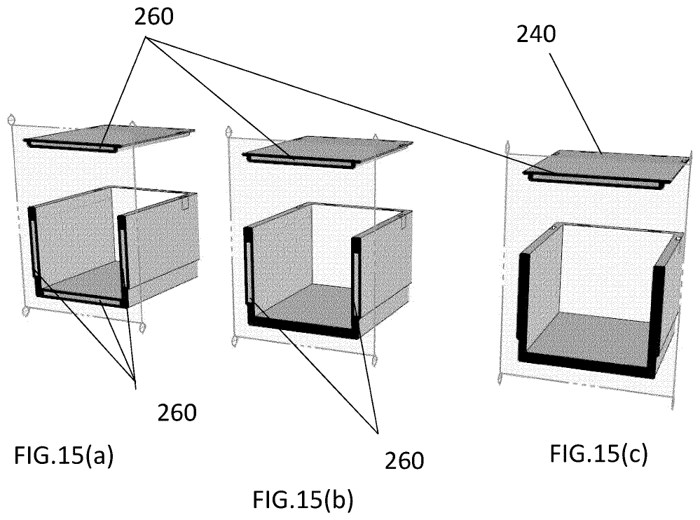

As shown in FIGS. 13 and 14, two refrigerant plates 260 are located in the cooler tote, one refrigerant plate is located in each of the opposing side walls 220. However, the cooling tote may comprise one, two, three or four refrigerant plates 260 as shown in FIG. 15. The cooling tote of FIG. 15(a) comprises four refrigerant plates, one in the lid, one in each of the opposing sidewalls and one in the base wall. This creates an interior space suitable for the storage of freezer items which are likely to thaw quickly. The cooling tote of FIG. 15(b) comprises three refrigerant plates, one in the lid and one in each of the opposing sidewalls. The cooling tote of FIG. 15(c) comprises one refrigerant plate in the lid. Therefore there are various configurations of the cooling tote. In particular, the lids 240 of the cooling tote may be interchangeable such that a lid without a pocket may replace a lid with a pocket and vice versa, if required.

In all the embodiments of the cooling tote described above and shown in FIGS. 7 to 15, the refrigerant plates are identical in terms of size and shape. This means that when a refrigerant plate is about to run of charge and will soon thaw out and no longer be able to cool the interior space of the cooling tote, or is running close to the end of a pre-determined cooling duration, the refrigerant plate can be removed and replaced with a charged refrigerant plate which will fit in the vacant pocket in the lid, opposing sidewall, opposing end walls or base wall of the cooling tote. There may be differences in the refrigerant in the refrigerant plates, for example water may be used a refrigerant for a cooling tote specifically used for cooling chilled grocery items suitable for the refrigerator and a mixture of a mineral salt and water may be used as a refrigerant for a cooling tote specifically used for cooling frozen grocery items.

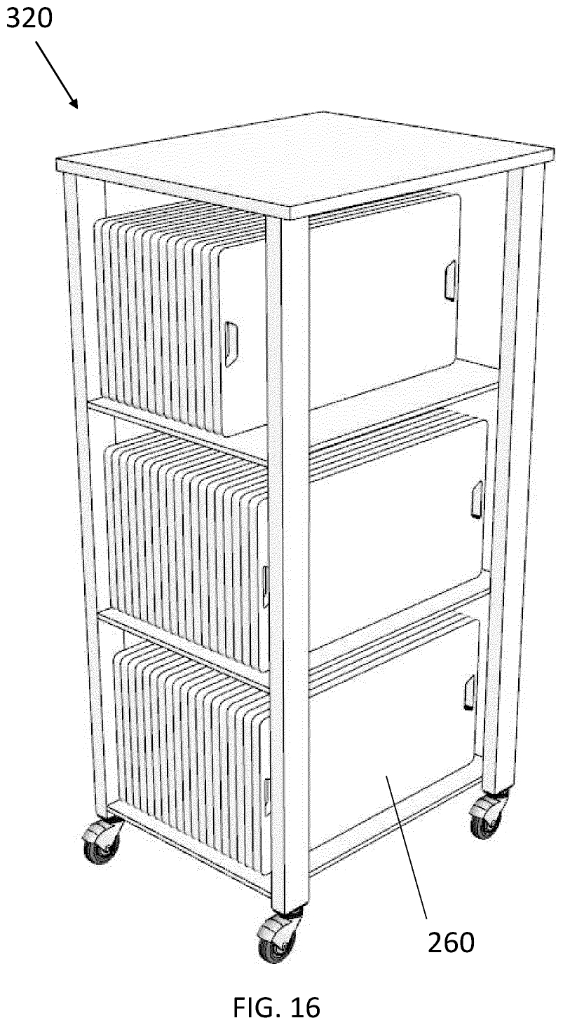

Refrigerant plates 260 which are removed from the cooling tote and need to be re-charged are stored in a trolley 320, as shown in FIG. 16. The trolley is configured such that it holds a plurality of refrigerant plates on multiple levels. In FIG. 16, the trolley has three levels and each level holds approximately twenty refrigerant plates 260. This particular arrangement provides space efficient storage of refrigerant plates whilst charging, but other arrangements may be used. On the trolley, each refrigerant plate is separated from an adjacent refrigerant plate.

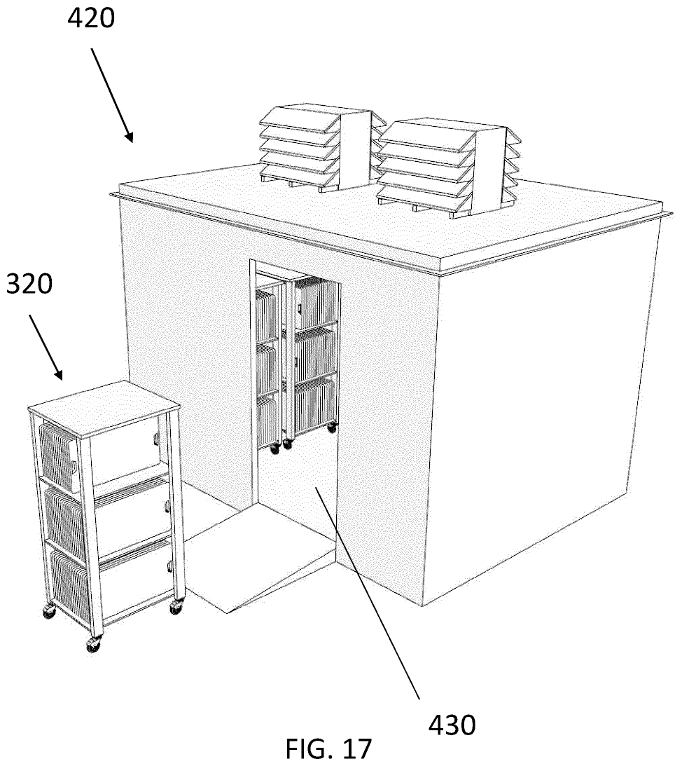

The refrigerant plates 260 for recharging are transported whilst on the trolley to a cooling station 420, as shown in FIG. 17. The cooling station comprises a refrigerating system for cooling the refrigerant plates in the temperature range of −30° C. to 0° C. so that the uncharged refrigerant plates in the cooling totes can be replaced by one or more refrigerant plates from the cooling station. The trolley 320 storing the uncharged refrigerant plates 260 is wheeled into the cooling station via a doorway 430 and the trolley with the refrigerant plates is stored in the cooling station 420 whilst the refrigerant plates are charged. It is important that the refrigerant is fully frozen and solidified before the refrigerant plate is used. If it is not frozen all the way through, the refrigerant will have a lower capacity to absorb heat and its cooling capacity will be reduced, and therefore will need recharging sooner. The freezing temperature of the refrigerant plate should be at least 5° C. lower than the refrigerant's melting temperature. As a result of each refrigerant plate being separated from an adjacent refrigerant plate on the trolley 320, cold air is allowed to circulate between the refrigerant plates thereby reducing the charging time or time taken for the refrigerant plates to freeze. The charging or freezing status of the refrigerant plates can be checked by shaking the refrigerant plates; any movement from a liquid or semi-liquid state means that the charging status is not complete and the refrigerant is not frozen. Alternatively, the refrigerant plates 260 can be stored in the cooling station 420 for a predetermined amount of time which ensures that the refrigerant plates are completely frozen. The predetermined amount of time may be between 2 and 5 hours or between 6 to 24 hours, for example 12 hours or 18 hours. Once the refrigerant plates are completely charged or frozen, they can replace any uncharged refrigerant plates in pockets in one or more cooling totes.

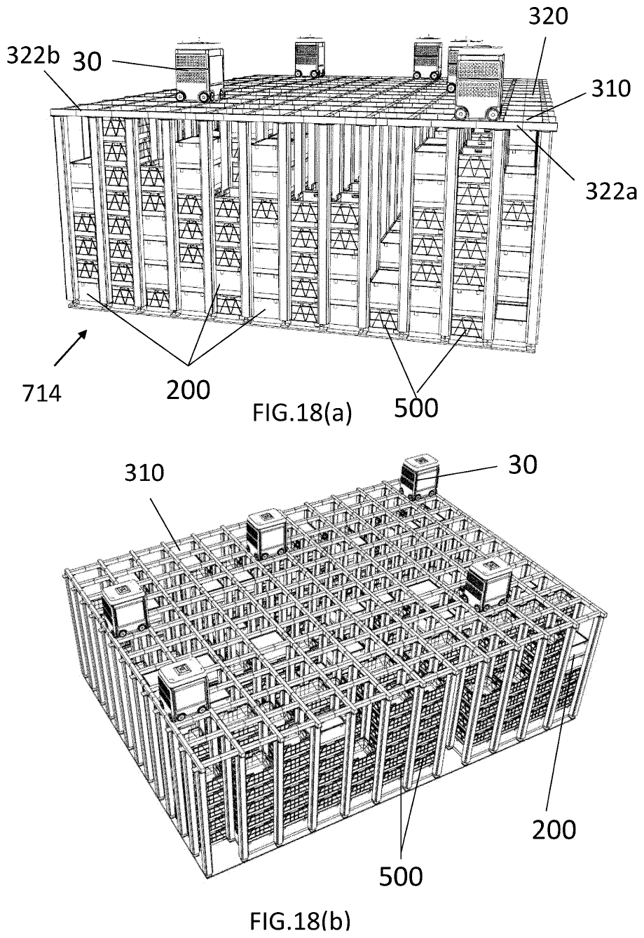

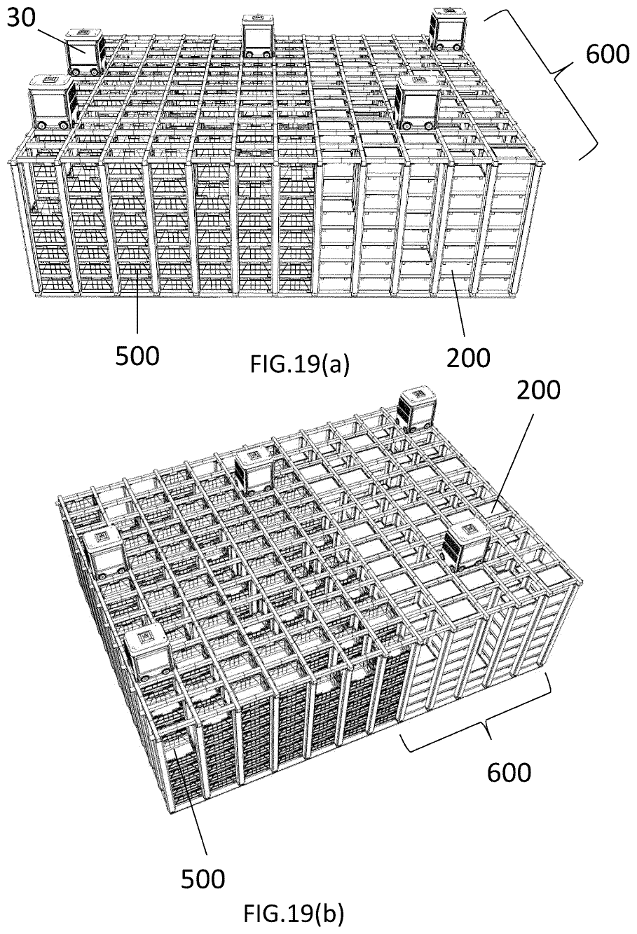

Cooling totes, being the same size and shape as standard storage containers, can be stored on the grid framework structure either mixed in with the ambient storage containers or separate from the standard storage containers. FIG. 18 shows cooling totes 200 being stored in the grid framework structure 714 with ambient storage containers 500. The grid framework structure 714 comprises a track system 320 comprising a first set of parallel rails or tracks 322a and a second set of parallel rails or tracks 322b extending transverse to the first set in a substantially horizontal plane to form a grid pattern comprising a plurality of grid spaces 310. Load handling devices 30 are moveable and operable on the tracks of the track system 320. Beneath the track system 320 is a plurality of storage columns in which the ambient storage containers 500 and cooling totes 200 are arranged in stacks. The cooling totes 200 are stacked and interspersed within the grid framework structure such that between 0 and 100% of a particular stack comprises cooling totes. Since the cooling totes use passive cooling, rather than active cooling, the grid framework structure 714 does not need to be altered to accommodate the cooling totes. Further, the passive cooling of the cooling totes means that the power sources of the load handling devices are not degraded as would happen in an active cooling system as a result of the low temperatures. In fact, the load handling devices can retrieve a cooling tote from the grid in the same way, using the gripping device, as for an ambient storage container. Thus, incorporating the cooling totes 200 into the grid framework structure 714 such that they are mixed in stacks with ambient totes 500 provides a cost efficient way of storing and retrieving chilled and frozen grocery goods. FIG. 19 shows an alternative arrangement of the grid framework structure in which the cooling totes 200 are arranged in a specific portion 600 on one side of the grid framework structure. The cooling totes are therefore segregated from the ambient storage containers and zoned into a region of the grid framework structure. By arranging the cooling totes in this way, any cool air that is lost from the cooling totes helps keep the adjacent cooling totes cool, thereby keeping the cooling totes cooler for longer periods of time. Thus, the predetermined cooling duration is increased. The predetermined cooling duration may be between 8 to 12 hours or between 24 to 30 hours. Despite the cooling totes being stacked in one area or portion 600 of the grid framework structure, any load handling device 30 can retrieve the cooling totes. Other arrangements of the cooling totes within the grid framework structure are also possible, for example, positioning the cooling totes 200 around the periphery of the grid framework structure.

Whilst the description above describes refrigerating plates receivable in the base wall, sidewalls, end walls and lid, the refrigerant may alternatively be integrated into the cooling tote such that charging of the refrigerant can also include placing at least a portion of the cooling tote, e.g. lid into the cooling station. In this case, when the refrigerant plate runs out of charge and has thawed, or is near to it predetermined cooling duration, the lid can be removed from the cooling tote, placed on a trolley such as the one shown in FIG. 16, transported to the cooling station of FIG. 17, re-charged in the cooling station before being placed on a cooling tote for cooling items in the interior space of the cooling tote. As the dimensions and shape of the cooling totes are substantially uniform to enable the cooling totes to be stacked in the grid framework structure, the lids of the cooling totes are easily exchangeable.

### Cooling Control System

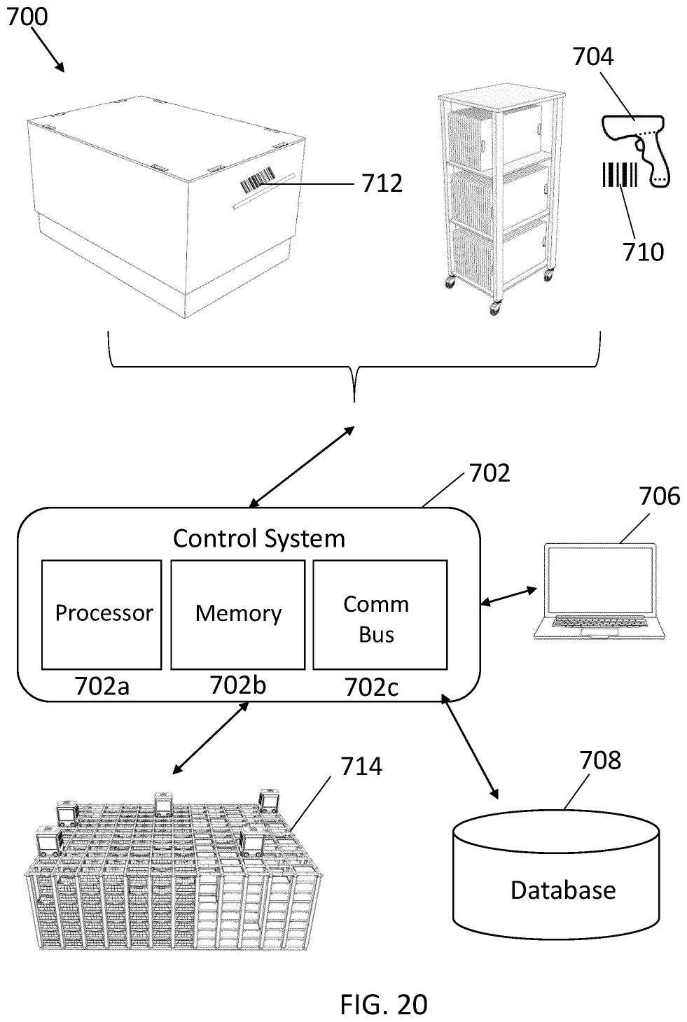

FIG. 20 shows a schematic representation of the cooling control system 700 according to an embodiment of the present invention comprising a control system 702, an input device 704, a user interface device 706 and a database 708. The control system 702 controls the operation of the cooling control system and comprises one or more processors 702a, a memory 702b (e.g. read only memory and random access memory) and a communication bus 702c. A local user interface 706, e.g. smart phone, tablet, smart watch, laptop, etc., is communicatively coupled to the control system 702 via a communication network over a wired or wireless transmitter/receiver. The communication network, for example, can be a local area network (LAN), a wide area network (WAN) or any other type of network. The one or more processors of the control system can execute instructions stored in the ROM and/or RAM to at least partially provide the functionality of the dispatch system described herein. The one or more processors of the control system are communicatively coupled to the wireless/wired transmitter receiver via the communication bus. The cloud (not shown) may form part of the control system such that processing and storage of data can be carried out in the cloud.

To identify one or more refrigerant plates in the cooling tote, each of the refrigerant plates comprises a label 710 comprising data associated with the identification of their respective refrigerant plate. The label 710 can be in the form of a barcode, e.g. 2D barcode, QR code, RFID tag. The identity of the refrigerant plate comprises data associated with the cooling capacity of the refrigerant contained within the plate and this depends on the goods for storage in the cooling tote. For maintaining frozen goods in a frozen state, typically the refrigerant plate provides cooling in the temperature range of −30° C. to −15° C. and is defined as a freezer plate. Equally, for maintaining chilled goods in a chilled state, typically the refrigerant plate provides cooling in the temperature range of 2° C. to 8° C. and is defined as a chilled plate. To determine the different types of refrigerant plates in the cooling tote and correlate the different types of refrigerant plates to the cooling capacity of the cooling tote, the identity of the refrigerant plate comprises data associated with the type of refrigerant plate.

A suitable input device 704, e.g. a barcode reader, can be used to read the label and the data associated with the identification of the refrigerant plate is inputted into the control system 702 via the input device 704 and subsequently, stored in a database 708. Optionally, a cooling tote can comprise a dedicated label 712 for identifying the cooling tote in storage in the grid framework structure discussed above. As with the refrigerant plate, data associated with the identification of the cooling tote is read by a suitable input device (not shown) and the data is subsequently stored in the database. The identity of the cooling tote can also be associated with the cooling capacity of the cooling tote. Like the refrigerant plate, the identity of the cooling tote can be defined as a freezer tote for providing a cooling capacity in the temperature range −30° C. to −15° C. and the identity of the cooling tote can be defined as a chilled tote for providing a cooling capacity in the temperature range −5° C. to 0° C. The control system is configured to correlate the identity of the cooling tote with the identity of the refrigerant plate type in the cooling tote so as to determine the cooling capacity of the cooling tote, i.e. freezer tote or cooling tote. The labelling of the cooling tote is not necessary as the one or more processors of the control system can execute instructions to track the position of a robotic load handling device carrying the cooling tote when it is instructed to deposit the cooling tote for storage in the grid framework structure 714. However, labelling of the cooling tote provides confirmation to the control system that the identified refrigerant plate is in the correct cooling tote.

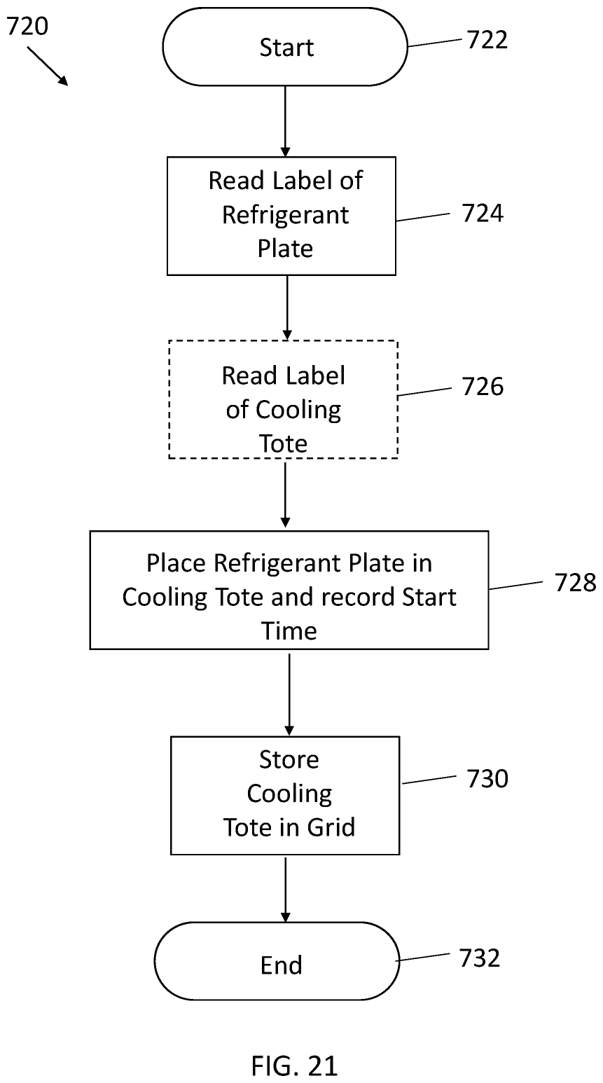

The flowchart 720 shown in FIG. 21 provides a brief outline of the stages in preparing a cooling tote for storage in the grid framework structure. In use, when a cooling tote is being prepared for storage of one or more items or goods at temperature lower than the ambient temperature, e.g. chilled or frozen grocery items, the one or more processors 702a of the control system 702 is instructed to receive data associated with the identification of refrigerant plate via the input device 704 to determine the type of refrigerant plate used to cool the cooling tote and this largely depends of the cooling capacity needed for the cooling tote. This is shown in FIG. 21 by the step 724 of the input device 704 reading a label on the refrigerant plate. The data associated with the identity of the refrigerant plate is stored in the database 708. As discussed above, preparation of the cooling totes occurs at a cooling station comprising a refrigerating system and a cooling chamber for cooling a plurality of refrigerant plates. The refrigerating system is controlled to ensure that the refrigerant in the refrigerant plates are perfectly frozen prior to being used in the cooling totes otherwise known as ‘charging’ the refrigerant plates. Charging of the refrigerant plates depends on whether the refrigerant plate provides a freezer cooling effect or a chilled cooling effect in the cooling tote.

Once, the identity of the refrigerant plate is identified, the refrigerant plate is placed inside a pocket in at least one base wall and/or opposing sidewalls and/or opposing end walls or lid of the cooling tote 728. In addition to identifying the type of refrigerant plate, the input device can also be used to read a label on the cooling tote 726 comprising the refrigerant plate. This is shown in FIG. 21 as a dashed box indicating that it is an optional step. The data associated with the identity of the cooling tote is subsequently stored in the database. The control system is configured to assign the identity of the refrigerant plate to the identity of the cooling tote comprising the refrigerant plate. A start time is recorded by the control system when the identity of the refrigerant plate is placed in the cooling tote which is recorded in the database. The start time provides an indication of the cooling time of the refrigerant in the cooling tote. This is repeated when other refrigerant plates are placed in different cooling totes. A lookup table is thus generated comprising data associated with the identity of the refrigerant plate, the identity of the cooling tote and the start time when the refrigerant plate was placed in the cooling tote and/or entered the grid framework structure. Once the refrigerant plate is placed in the cooling tote, the cooling tote is transferred to the grid framework structure (termed ‘grid’ in FIG. 21) for storage 730. The start time can optionally include the time when the cooling tote comprising the refrigerant plate enters the grid framework structure. Instead of or in addition to recording the identity of the cooling tote via a label on the cooling tote, the identity of the cooling tote can also include the position of the cooling tote in storage in the grid framework structure. For example, the position of the robotic load handling device on the track system can be used to determine the position of the cooling tote in the grid structure in the X-Y plane. For example, sensors at the intersection of the tracks extending the X and Y axis can be used to determine the position of the robotic load handling device in the horizontal plane on the track system and the position of the cooling tote vertically in a stack of storage containers can be determined from the depth the cooling tote is lowered in a given stack.

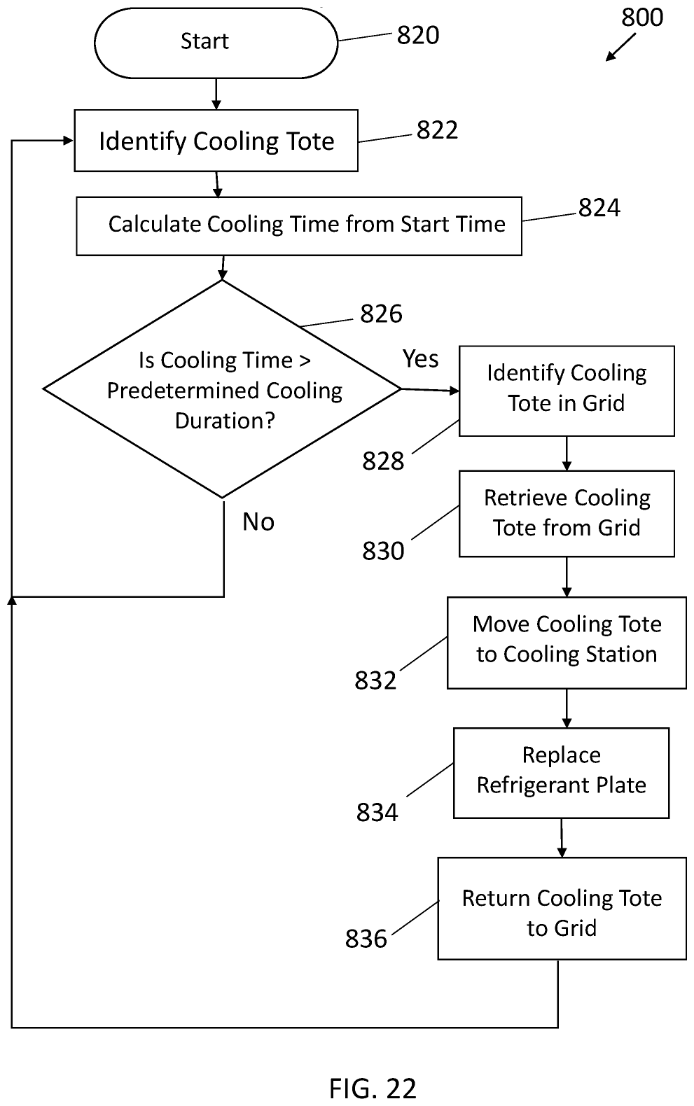

The one or more cooling totes according to the present invention are constructed so that the one or more cooling totes can be stored amongst the stacks of the storage containers in an ambient temperature environment. However, the refrigerant plates in the cooling totes remain charged or in a frozen state to provide a useful cooling effect for a limited period of time, known as the predetermined cooling duration. Once the predetermined cooling duration has expired or is approaching expiry, the cooling efficiency of the refrigerant plate diminishes and the refrigerant plate would need to be recharged or replaced with a freshly charged plate. FIG. 22 is an example of a flowchart 800 detailing the stages in monitoring the status of the cooling totes in storage in the grid framework structure. The process steps begin with the control system identifying a cooling tote 822 in the lookup table and calculating the cooling time from the start time 824 discussed above. Practically, the control system continually monitors the cooling time and compares the cooling time to its corresponding predetermined cooling duration in the lookup table. Any cooling time that has exceeded its predetermined cooling duration or is approaching its predetermined cooling duration is shown as a ‘red’ flag in the lookup table and provides the control system with an indication of the need to recharge or replace the refrigerant plate in the cooling tote at a cooling station.

In determining whether the refrigerant plate needs to be recharged or charged at a cooling station, the one or more processors of the control system execute instructions to determine 826 whether the cooling time is greater than the predetermined cooling direction. If the answer to this question is ‘yes’, the control system identifies 828 the suspect cooling tote in the grid framework structure (shown as ‘grid’ in FIG. 22). As discussed above, the identification of the cooling tote can include the position of the cooling tote in the grid framework structure. Such data can be found in the lookup table discussed above. Once the identity of the suspect cooling tote has been identified, the control system is configured to provide instructions to a robotic load handling device operable on the tracks to retrieve the cooling tote from the grid framework structure 830 and move the cooling tote to the cooling station 832. At the cooling station, the expended refrigerant plate is replaced with a charged refrigerant plate 834 and the process described in FIG. 22 repeats for identifying the refrigerant plate in the cooling tote and correlating the identity of the refrigerant plate to the cooling tote. Once the cooling tote has been replenished with a charged refrigerant plate, the control system is configured to return the cooling tote to the grid framework structure for storage 836. The process steps repeat for the other cooling totes in storage in the grid framework structure and so on in a continuous cycle.

Typically, refrigerant plates, particularly those based on an eutectic mixture can maintain their cooling time over predetermined cooling duration of 8 hours to 12 hours or 24 to 30 hours depending on the type of eutectic mixture. This may be a sufficiently long storage time for one pass of some grocery items or goods in storage to fulfil a customer order without the need to return the cooling totes to the cooling station. Such items or goods include convenience grocery items or goods such as milk, butter for chilled goods and ice cream for frozen items or goods.

Whilst the control system is described with reference to refrigerant plates, the refrigerant plate can equally be at least a portion of the cooling tote, in particular, the lid of the cooling tote. Thus, the processing steps of identifying the refrigerant plates and determining the cooling time of the refrigerant plates can be applied to the lids of the cooling totes. The lid of the cooling tote represents the least bulky part of the cooling tote and therefore, will not occupy a lot of space of the cooling station. As discussed above, the refrigerant can be integrated into the lid of the cooling tote. Thus, instead of charging the refrigerant plates in the cooling station, the cooling station can be configured to charge a plurality of lids. Since the dimensions of the cooling totes are generally uniform, the lids can be exchangeable between different cooling totes. This allows a plurality of lids to be charged at the cooling station and the control system being configured to instruct a robotic load handling device to retrieve a cooling tote from the grid framework structure once cooling time of the refrigerant in the lid has reached or is approaching its predetermined cooling duration. Once at the cooling station, the process of replacing the lid of the cooling tote with a charged lid from the cooling station proceeds as described in the processing steps in FIG. 21. Equally, the control system monitors the status of the refrigerant in the lid by generating a lookup table with the recorded start time the lid was placed on the cooling tote and the time that has elapsed from the start time, i.e. cooling time. Equally plausible in the present invention is that the entire cooling tote can be charged at the cooling station rather than the lid. A plurality of cooling totes with an integrated refrigerant can be charged at the cooling station.

1.-25. (canceled)

26. A storage and retrieval system comprising:
a grid framework structure including a track system and a plurality of storage columns arranged adjacent to one another, said track system including a first set of parallel rails or tracks and a second set of parallel rails or tracks extending transverse to the first set in a substantially horizontal plane to form a grid pattern including a plurality of grid spaces;
a plurality of storage containers arranged in stacks in each of the plurality of storage columns, and located beneath the track system, each of the plurality of storage containers including a base wall and opposing sidewalls and end walls extending from the base wall to form a box-like structure having an opening; and
at least one load handling device disposed on the track system, configured and arranged to move laterally above the stacks on the rails, the load handling device including a lifting device configured and arranged to lift one or more storage containers, or parts thereof, from a stack, the lifting device including a container gripper assembly configured to releasably grip a storage container and a lifting drive assembly configured to raise and lower the container gripping assembly;
wherein one or more of the plurality of storage containers includes a lid for closing the opening of the one or more storage containers to define a cooling tote;
wherein at least one of the base wall, and/or opposing sidewalls and/or opposing end walls and/or the lid of the cooling tote includes a pocket housing a refrigerant; and
wherein the refrigerant has a freezing point in a range of −30° C. to 0° C. for storing frozen or chilled foods.

27. The storage and retrieval system of claim 26, wherein the refrigerant comprises:
an eutectic mixture having a freezing point in a range of −30° C. to −15° C. for cooling frozen foods and/or a freezing point in a range −5° C. to 0° C. for cooling chilled foods.

28. The storage and retrieval system of claim 26, wherein the refrigerant is contained within the lid of the one or more cooling totes.

29. The storage and retrieval system of claim 26, wherein at least a portion of the at least one base wall, opposing sidewalls, opposing end walls and/or the lid of the one or more cooling totes is made from a thermally insulating foam.

30. The storage and retrieval system of claim 26, wherein the at least one of the base wall, opposing sidewalls, opposing end walls and/or the lid of the one or more cooling totes comprises:
a vacuum insulated core.

31. The storage and retrieval system of claim 26, wherein the base wall and the opposing sidewalls and end walls extending from the base wall of the box-like structure of each of the one or more cooling totes form an inner shell and each of the one or more cooling totes comprises:
a rigid outer shell housing the inner shell.

32. The storage and retrieval system of claim 26, wherein the refrigerant is contained within a plate to define a refrigerant plate such that when the refrigerant has a freezing point in a range −30° C. to −15° C., the refrigerant plate is defined as freezer plate, and when the refrigerant has a freezing point in a range −5° C. to −0° C., the refrigerant plate is defined as a chilled plate.

33. The storage and retrieval system of claim 32, wherein the at least one base wall, and/or opposing sidewalls and/or opposing end walls and/or the lid of each of the one or more cooling totes including the pocket comprises:
one or more cut-outs extending into an interior of the box-like structure such that at least a portion of the refrigerant plate is exposed in the interior space of the one or more cooling totes.

34. The storage and retrieval system of claim 33, wherein the refrigerant plate is configured to be removably receivable within the pocket of the at least one of the base wall, and/or opposing sidewalls and/or opposing end walls and/or the lid of each of the one or more cooling totes.

35. The storage and retrieval system of claim 26, wherein the cooling tote comprises:
a plurality of openings for engagement with the container gripping assembly.

36. The storage and retrieval system of claim 35, comprising:
a control system including one or more processors and memory storing instructions that when executed by the one or more processors is configured to determine the duration of time of the one or more cooling totes in the grid framework structure by:
i) recording a start time when the refrigerant plate is placed in at least one of the base wall, and/or opposing sidewalls and/or opposing end walls and/or the lid of each of the one or more cooling totes;
ii) determining a duration of time that has elapsed in the one or more cooling totes from the recorded start time to define a cooling time; and
when the cooling time exceeds or approaches a predetermined cooling duration, instructing a robotic load handling device operable on the track system to remove the one or more cooling totes from the grid framework structure.

37. The storage and retrieval system of claim 36, wherein the start time is a time when the one or more cooling totes enter the grid framework structure.

38. The storage and retrieval system of claim 37, wherein the one or more cooling totes are removeable to a cooling station comprising:
a plurality of refrigerant plates, said cooling station comprising a refrigeration system for cooling a plurality of the refrigerant plates in a temperature range of −30° C. to 0° C., one or more refrigerant plates in the one or more retrieved cooling totes being configured to be replaced by one or more refrigerant plates from the cooling station.

39. The storage and retrieval system of claim 38, wherein each of the plurality of refrigerant plates comprises:
a label readable by an input device for establishing an identity of each of the plurality of refrigerant plates in the cooling station or cooling tote or grid framework structure.

40. The storage and retrieval system of claim 39, wherein the identity comprises:
data associated with whether the refrigerant plate is a freezer plate or a chilled plate.

41. The storage and retrieval system of claim 40, wherein the control system is configured:
i) to assign an identity of one or more refrigerant plates to the one or more cooling totes;
ii) to track a position of the one or more cooling totes within the grid framework structure; and
iii) to store the position of the one or more cooling totes in the grid framework structure in a database.

42. The storage and retrieval system of claim 41, wherein the control system is configured:
to assign the identity of one or more refrigerant plates to the one or more cooling totes depending on whether the goods are chilled goods or frozen goods.

43. The storage and retrieval system of claim 40, wherein the control system is configured:
to monitor a status of one or more cooling totes in the grid framework structure by:
i) retrieving data associated with an identification of one or more refrigerant plates in the database;
ii) correlating the identification of the one or more refrigerant plates to one or more cooling totes in the grid framework structure; and
iii) determining a status of the one or more refrigerant plates by comparing the cooling time of the one or more refrigerant plates to its respective predetermined cooling duration.

44. The storage and retrieval system of claim 43, comprising:
a lookup table, wherein data associated with correlation of the identification of the one or more refrigerant plates to one or more cooling totes in the grid framework structure are stored in the lookup table.

45. The storage and retrieval system of claim 44, wherein the control system is configured to retrieve a cooling tote from the grid framework structure by:
i) retrieving data associated with a position of the cooling tote in the grid framework structure from the lookup table; and
ii) instructing a robotic load handling device operable on the track system to retrieve the cooling tote from the grid framework structure using the position data.
